(19) United States
(12) Patent Application Publication
(10) Pub. No.: US 2015/0281854 A1
(43) Pub. Date: Oct. 1, 2015

(54) DIRECT DIGITAL AUDIO ADAPTER FOR HEARING AIDS

(71) Applicant: SIEMENS MEDICAL INSTRUMENTS PTE. LTD, Singapore (SG)

(72) Inventors: PETER NIKLES, ERLANGEN (DE); ULRICH SCHAETZLE, ERLANGEN (DE)

(21) Appl. No.: 14/669,245

(22) Filed: Mar. 26, 2015

(30) Foreign Application Priority Data
Mar. 26, 2014 (DE) 102014205610.1

(51) Int. Cl. H04R 25/00

(52) U.S. Cl. CPC H04R 25/30

(57) ABSTRACT

An apparatus for sending a second digital audio signal to a hearing aid and has a power supply and an induction loop for sending an alternating magnetic field. The apparatus also has a controller which is galvanically, capacitively or inductively connected to the induction loop. Here the controller is configured to convert an incoming first audio signal into the second digital audio signal, and using the second digital audio signal to create a control signal for sending the second digital audio signal by use of the induction loop.

### CROSS-REFERENCE TO RELATED APPLICATION

This application claims the priority, under 35 U.S.C. §119, of German application DE 10 2014 205 610.1, filed Mar. 26, 2014; the prior application is herewith incorporated by reference in its entirety.

### BACKGROUND OF THE INVENTION

### Field of the Invention

The invention relates to an apparatus for sending a digital audio signal to a hearing aid.

Hearing aids are wearable hearing apparatuses, which serve to assist people with hearing difficulties. In order to accommodate numerous individual requirements, various types of hearing aids are available such as behind-the-ear (BTE) hearing devices, hearing device with external receiver (RIC: receiver in the canal) and in-the-ear (ITE) hearing devices, for example also concha hearing devices or completely-in-the-canal (ITE, CIC) hearing devices. The hearing devices listed by way of example are worn on the outer ear or in the auditory canal. Also available on the market are bone conduction hearing aids, implantable hearing aids or vibrotactile hearing aids. The damaged hearing is thus stimulated either mechanically or electrically.

The key components of hearing devices are principally an input transducer, an amplifier and an output transducer. The input transducer is generally an acoustoelectric transducer, e.g. a microphone, and/or an electromagnetic receiver, e.g. an induction coil. The output transducer is most frequently realized as an electroacoustic transducer e.g. a miniature loudspeaker, or as an electromechanical transducer e.g. a bone conduction earpiece. The amplifier is generally integrated in a signal processing unit. The power supply is usually provided via a battery or a chargeable accumulator.

External induction coils which transmit an alternating electromagnetic field have been known for some time, the field being analog modulated with an audio signal. This allows hearing-impaired people to be provided with audio signals in lecture rooms, concert halls or churches without interfering ambient noise or reverberation.

Hearing aids having a direct electrical audio connection, which is also referred to as an audio shoe, are known for the direct provision of high-quality audio signals. Published, European patent application EP 2222095 A1, corresponding to U.S. Pat. No. 8,494,191, also discloses an induction loop being attached around the neck and featuring a converter which converts an incoming audio signal into an analog signal for the induction coil so as to control the induction coil in the hearing device as a signal input. The converter can receive audio signals as analog radio signals or also via bluetooth.

However a cable connection is often found to be bothersome, and analog wireless connections are subject to external interference effects from other sources of alternating electromagnetic fields such as power electronics or radio technology.

### SUMMARY OF THE INVENTION

An object of the present invention is therefore to provide an apparatus for a hearing aid as well as a system capable of supplying a hearing aid with an audio signal conveniently and without interference.

The apparatus according to the invention for sending a second digital audio signal to a hearing aid has a power supply and an induction loop for sending an alternating magnetic field. The apparatus also has a controller which is galvanically, capacitively or inductively connected to the induction loop. Here the controller is configured to convert an incoming first audio signal into the second digital audio signal, and using the second digital audio signal to create a control signal for sending the second digital audio signal by the induction loop. The power supply is configured to take the power required to generate the control signal from the first audio signal. This can be performed for example by decoupling and rectifying an alternating current portion of the first audio signal or decoupling a DC portion of the first audio signal.

The apparatus according to the invention advantageously sends a digitally encoded second audio signal by the interference loop. Digital audio signals are less susceptible to interference compared to analog interference signals and produce a better sound quality provided suitable encoding or compression is selected. The power supply according to the invention advantageously eliminates the need for an energy store, such as a battery or accumulator, which require an interruption to operation for charging or exchange purposes.

The system according to the invention for sending a second digital audio signal to a hearing aid has an apparatus according to the invention for sending a second digital audio signal to a hearing aid and also an audio signal source configured to generate the first audio signal from an audio signal to be transferred and from a third signal. The third signal is suitable for ensuring that power is provided to the sending apparatus by the power supply. In this regard, the third signal does not result in any audible noise for a person wearing the hearing aid. Here it is conceivable that the first audio signal contains signal components which in themselves are not captured as audio signals, for example a direct current portion or a high frequency portion.

The audio signal source advantageously allows the sending apparatus to be supplied with power. Thus the need for a battery in the apparatus, requiring additional space and increasing the weight, can be eliminated. Furthermore, no regular effort is required to exchange or charge it.

Further advantageous developments of the invention are set out in the dependent claims.

In an embodiment of the apparatus according to the invention the controller has a monitoring device configured to monitor a level of the first audio signal in a predefined frequency range and to suppress the creation of the control signal if a predetermined threshold value of the level is not reached.

In this way it is advantageously possible to suppress creating an alternating electromagnetic field if a reasonable signal of a sufficient level is no longer present. This prevents, for example, an interfering noise or background noise from being transferred. At the same time it is conceivable that the hearing aid temporarily deactivates receive circuits in the event of a missing alternating field thus saving energy.

In one conceivable embodiment of the apparatus according to the invention, the apparatus has means to decode control instructions encoded in the first audio signal.

This advantageously allows an audio source, which can for example also be a smart phone with a corresponding application, to transfer control signals via the apparatus to a hearing aid and thus to control the hearing aid in this manner.

In one conceivable embodiment of the apparatus the third signal is an electrical DC signal.

A DC signal can be easily separated in the apparatus from an audio signal, does not create any audible artifacts and at the same time provides a permanent power supply to the apparatus, the power supply being independent of the volume of the audio signal.

In one conceivable embodiment of a system according to the invention the third signal is an audio signal in a frequency range that is imperceptible to the person wearing the hearing aid.

An audio signal which is inaudible to the person wearing the hearing aid can easily overlay the first audio signal and be separated therefrom, for example via a high pass or low pass. As this is not perceptible to the person wearing the hearing aid, it can also always be present without disturbing the user. In this way a permanent power supply to the inventive apparatus can be ensured.

In one conceivable embodiment of the system according to the invention the audio signal source is configured so as to encode control commands in the third signal for the apparatus for sending.

This advantageously allows the audio source, which can for example also be a smart phone with a corresponding application, to transfer control signals via the apparatus to a hearing aid and thus to control the hearing aid in this manner.

Other features which are considered as characteristic for the invention are set forth in the appended claims.

Although the invention is illustrated and described herein as embodied in a direct digital audio adapter for hearing aids, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of an embodiment of a system according to the invention with an embodiment of an inventive apparatus and an audio source;

FIG. 2 is a schematic view of a further embodiment of the system according to the invention with a further embodiment of the inventive apparatus and the audio source;

FIG. 3 is a schematic view of a first embodiment of a power supply of the inventive apparatus from FIG. 1;

FIG. 4 is a schematic view of a second embodiment of the power supply of the inventive apparatus from FIG. 1;

FIG. 5 is a schematic view of an embodiment of the power supply;

FIG. 6 is a schematic view of a hearing aid for use with an inventive apparatus for sending a digital audio signal; and

FIG. 7 is a graph showing exemplary forms for an audio signal to be transferred, a third signal and a first audio signal.

### DETAILED DESCRIPTION OF THE INVENTION

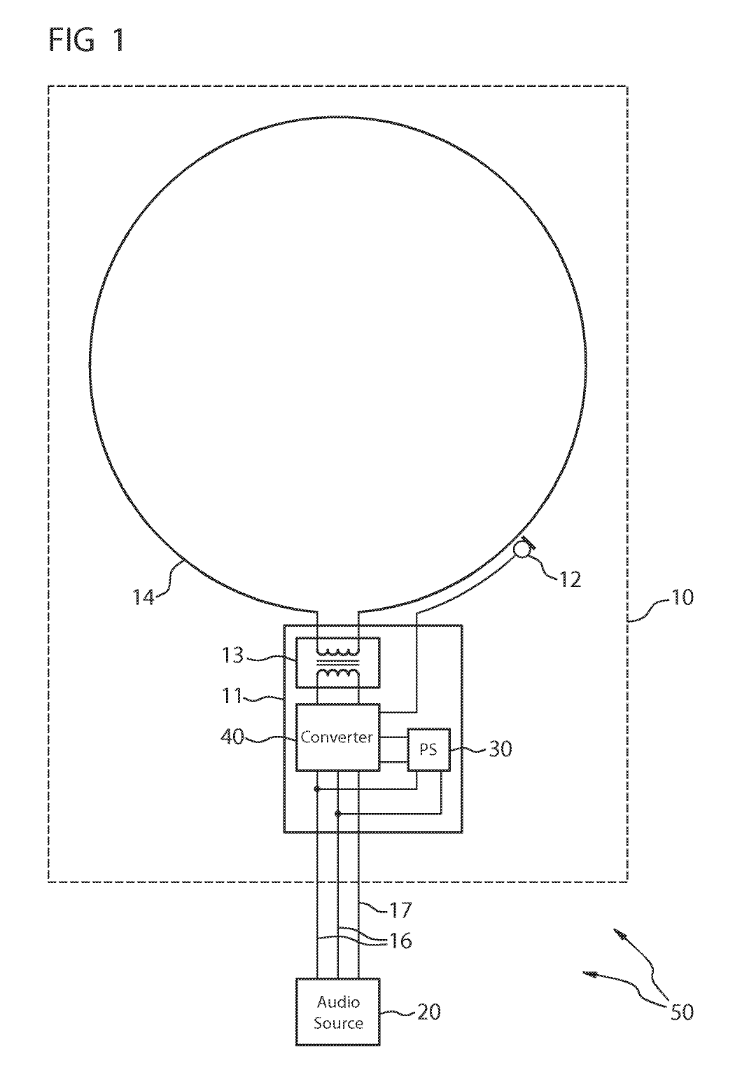

Referring now to the figures of the drawings in detail and first, particularly to FIG. 1 thereof, there is shown a schematic representation of an embodiment of an inventive system 50. The system 50 has an inventive apparatus 10 for sending a second digital audio signal, and an audio source 20.

The apparatus 10 has an induction loop 14 configured in one possible embodiment to be positioned around the neck of the person wearing a hearing aid 100 so that it generates an alternating electromagnetic field in the area of the ear of the person wearing the hearing aid when an alternating current flows through it.

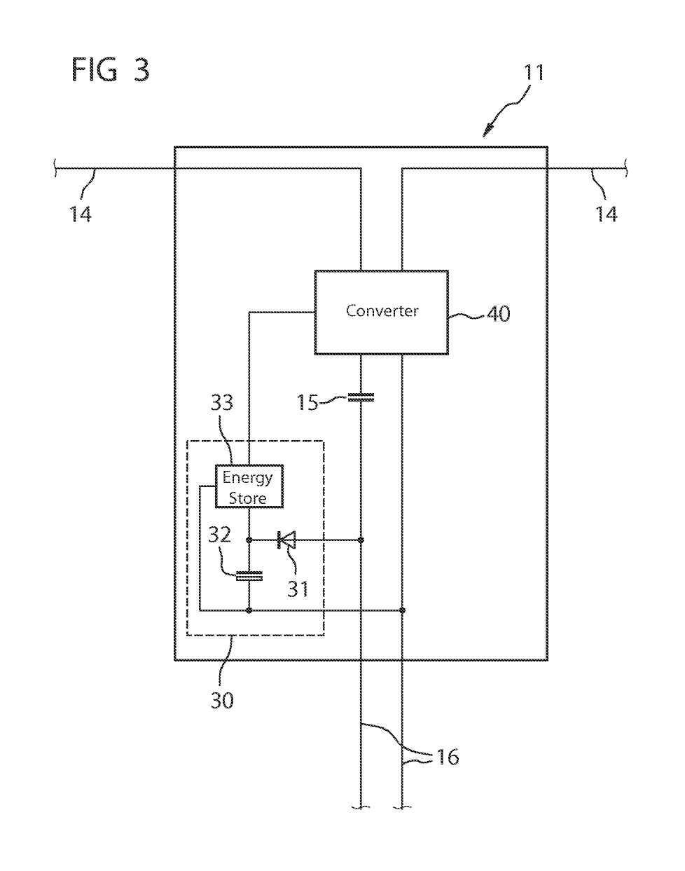

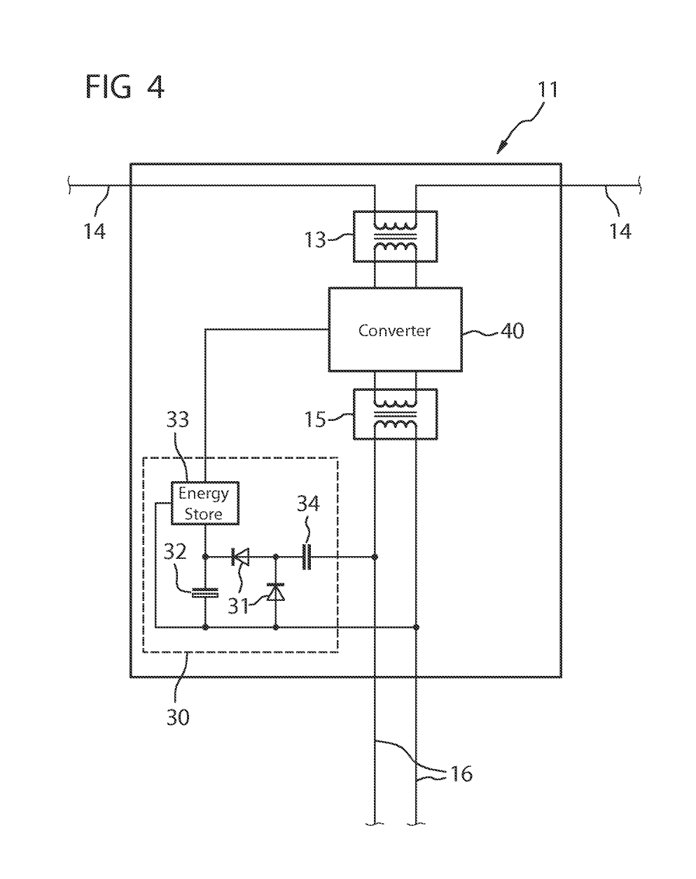

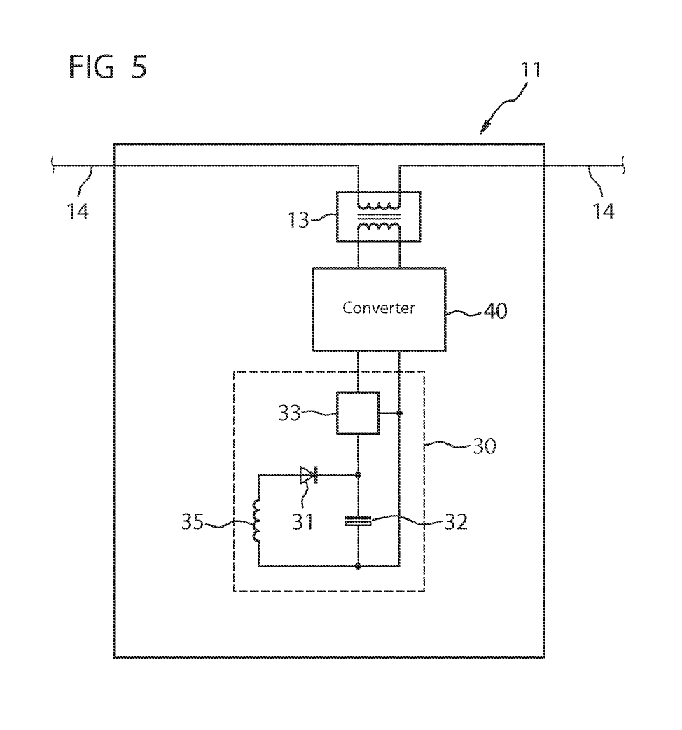

The alternating current is generated by a controller 11. The controller 11 has a power supply 30 which supplies a converter 40 with electrical energy. Possible embodiments of the power supply 30 are shown in FIG. 3, FIG. 4 and FIG. 5.

A first audio signal is fed in via a signal line 16. The first audio signal can be encoded in analog or digital form. The first audio signal is fed into both the power supply 30 and the converter 40.

The converter 40 converts the first audio signal into a second digital audio signal suitable for transfer via an induction loop. Here in particular encoding and modulation methods requiring a low energy consumption for the transfer are preferred. These are specific encoding and modulation methods, as also used for transfers between hearing aids which perform binaural processing.

Frequency Shift Keying (FSK), Phase Shift Keying (PSK), Bi-Phase Shift Keying (BPSK), Quadruple-Phase Shift Keying (QPSK) or also Differential Phase Shift Keying (DPSK) can be used for example as modulation methods. Conceivable encoding methods for digital audio encoding are for example G.711, G.722 or G722.2, characterized by a low latency time. However, other methods with longer latency times, such as MP3, are also possible.

A module or chipset, as also used in the hearing aids 100, is preferably used here so that in the case of a binaural hearing aid 100 no changes need to be made to the hardware in order to receive and evaluate the second digital audio signal.

The converter 40 has a signal output which is in a signal connection with an inductive coupling 13, and generates an alternating current in the induction loop 14, resulting in the apparatus 10 transferring the second digital audio signal to a hearing aid 100.

In one possible embodiment the apparatus 10 optionally also has a microphone 12 so that the apparatus 10 in conjunction with the hearing aid 100 and a smart phone as the audio source 20 can be used as hands-free equipment. To this end a further microphone line 17 is provided for transferring an audio signal of the microphone 12 from the apparatus 10 to the smart phone.

In a conceivable embodiment of the apparatus according to the invention the controller has a monitoring device configured to monitor a level of the first audio signal in a predefined frequency range and to suppress the creation of the control signal if a predetermined threshold value of the level is not reached. Preferably a frequency range perceptible to the person wearing the hearing aid, for example between 50 Hz and 4 kHz or between 100 Hz and 2 kHz or between 100 Hz and 1 kHz, should be provided as the predetermined frequency range. As the predetermined threshold value for the signal of an audio source a level of 1 V, 500 mV, 100 mV or 50 mV can be provided or its equivalent in a digital representation of the audio signal. Preferably the threshold level is above the signal-to-noise distance, for example 5, 10 or 20 dB above the noise level of the signal.

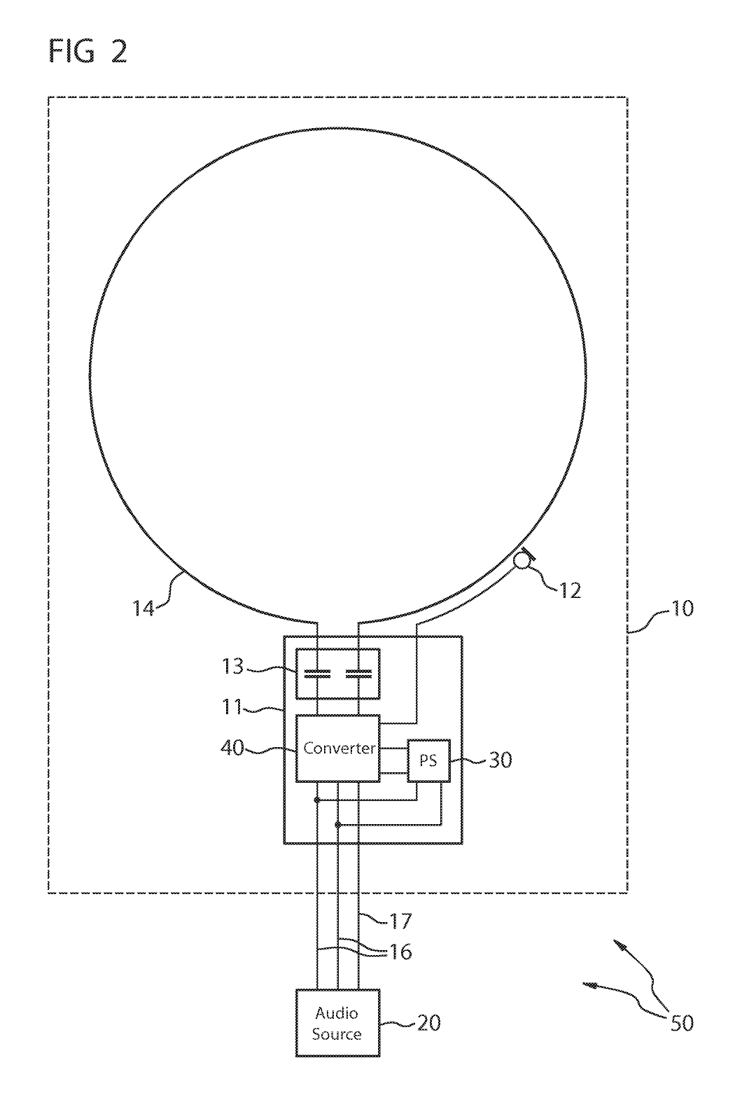

FIG. 2 shows a further embodiment of an inventive system 50. The same objects are assigned the same reference characters here.

The embodiment in FIG. 2 differs from the embodiment in FIG. 1 in that the induction loop is not inductively connected via a coil or transmitter, but rather the connection 13 takes place via capacitors.

In principle in one embodiment of the invention it is also conceivable that there is no signal connection in the form of a cable between the audio source 20 and the controller 11. Instead it can be a radio link using radio waves. For example use of the bluetooth standard is conceivable wherein other digital or analog transmission methods can inventively also be used for audio signals via radio waves. Transmission using light would also be conceivable for example, particularly in the infrared range.

In this case an embodiment of the power supply is conceivable, as explained in more detail in FIG. 5.

Here it is possible that the microphone 12 has a signal connection with the controller 11. In this case the controller 11 has an amplifier and an A/D converter so that the signal from the microphone 12 can be digitized and transferred to the audio source 20 via the radio link. This is particularly advantageous when the audio source 20 is a smart phone so that the apparatus 10 can be connected for example as a headset via bluetooth.

FIG. 3 shows an exemplary embodiment of an inventive apparatus 10 with a power supply 30. The power supply 30 is electrically connected to the signal line 16 via which the first audio signal of the apparatus is fed.

The first audio signal on the signal line 16 is rectified by a rectifying element 31 and fed to an energy storage unit 32. To this end the rectifying element 31 is connected on one side to a first strand of the signal line 16 and on the other side to a first pole of the energy storage unit 32. A diode or also a more complex circuit such as a bridge rectifier or an active rectifier can serve as a rectifying element 31. Rectifying elements with a low conducting-state voltage, for example Schottky diodes, are particularly preferable. For this purpose, the level of an audio signal must be greater than the conducting-state voltage of the rectifying element. So as not to attenuate the first audio signal to too great an extent, a resistance can also be provided for example between the signal line 16 and the rectifying element 31.

It is also conceivable however that the first audio signal has a DC portion or an alternating current in an audio range not audible to the person wearing the hearing aid, for example in the infrasound range below 10 Hz or in the ultrasound range above 15 kHz for example. The advantage here is that these signals are permanently present even if no audible sound is transferred and they provide the apparatus with power. Digital first audio signals also have an alternating current portion which can be used for permanent power supply after rectification with the displayed circuit.

The energy storage unit 32 is electrically connected on one side to the rectifying element 31 and on the other side to a reference pole. In the example shown this is a second strand of the signal line 16. When using a bridge rectifier as the rectifying element 31 this can however also be a separate connection of the rectifying element 31. The energy storage unit 32 aligns itself according to the nature of the first audio signal on the signal line 16 and of the frequency range used for the power supply. If a direct voltage is overlaid onto the audio signal the energy storage unit 32 can be a capacitor with low capacitance or can be eliminated completely as there are no interruptions to the voltage supply.

If the first audio signal has permanent alternating current portions, be it as inaudible sounds or as an alternating current portion of a digital encoding, the capacitance of the energy storage unit is configured to bridge at least one period of this alternating current portion. Typical values for a capacitance of the energy storage unit are then at least in the microfarad range.

If the energy from the power supply is gained solely from an analog first audio signal then the energy storage unit must also bridge short pauses in the first audio signal. For this reason, the capacitance of the energy storage unit 32 must lie in the range of hundreds of microfarads or millifarads. So-called super capacitors or rapid-charging accumulators can then for example be used as an energy storage unit 32.

Depending on the first audio signal, the configuration of the energy storage unit 32 and the requirements of the converter 40 supplied with power from the power supply 30, the voltage supplied by the energy storage unit 32 must continue to be smoothed or also multiplied. A regulator can be provided for smoothing. Here it is advantageous if the regulator is simultaneously configured as a voltage transformer 33 so that even in the event of a low amplitude of the alternating current in the first audio signal sufficient power supply for the converter 40 can be provided. The voltage transformer 33 is arranged between the energy storage unit 32 and the converter 40 and maintains the voltage at a required value for the converter 40. For example the voltage transformer 33 can be configured as an inductive switching transformer or as a capacitive charge pump. In the event of sufficiently high voltage or amplitude of the first audio signal, the voltage transformer 33 can also be a simple series regulator.

The signal line 16 is decoupled in terms of direct current from an audio signal input of the converter 40 by a direct voltage decoupling element 15, realized in FIG. 3 by a capacitor, so that only the alternating current portions of the analog or digital first audio signal make it to the converter 40. Only the other strand of the signal line 16 is galvanically coupled with the converter 40 as a ground reference potential.

Here it is also conceivable that the first audio signal on the signal line 16 is transferred symmetrically. In this case a capacitor can be provided as a direct current decoupling element at both strands of the signal line 16. A transmission transformer or particularly in the case of a digital first audio signal a direct current decoupling by an optocoupler is also conceivable.

It is also conceivable in a possible embodiment of the invention for the controller 40 to be directly galvanically coupled without connection 13 to the induction loop 14. In this way additional space can be saved for an inductive transmitter or capacitances in a connection 13.

FIG. 4 shows a further exemplary embodiment of an apparatus 11 with an alternative power supply 30. The same elements are designated with the same reference characters.

The embodiment in FIG. 4 has two rectifying elements 31 which are connected in such a way that both a positive half-wave and a negative half-wave of an alternating current signal contribute towards charging the energy storage unit 32. Furthermore the rectifying elements 31 are not galvanically connected to a strand of the signal line 16, the strand leading to an alternating current signal, but rather there is a capacitive coupling by a coupling capacitor 34. A capacitive coupling with the second strand of the signal line 16 or a connection by a second transmission transformer would also be conceivable. Furthermore the signal line 16 is inductively connected to the converter 40 by a transmission transformer 15.

In the embodiment in FIG. 4 the power supply of the apparatus 10 cannot be achieved via a DC portion on the signal line 16 but only via an alternating current portion, be it as a portion in the audible or inaudible spectrum of an analog audio signal or as an alternating current portion of an encoding of a digital audio signal.

FIG. 5 shows an alternative embodiment of an apparatus 11 with a further embodiment of the power supply 30 as would be conceivable for example in the apparatus 10 in FIG. 2. The same elements are designated with the same reference characters.

The apparatus 10 in FIG. 2 does not have a signal line 16 for supplying a first audio signal, but rather the first audio signal 20 is transferred between the audio source 20 and the apparatus 10 by a radio transmission method.

Accordingly it is also not possible to supply the power supply 30 with energy by the signal line 16. It is however conceivable to have a chargeable accumulator as an energy storage element, which is charged by a rectifying element 31 which in turn is charged by a charging coil 35, into which energy is inductively fed from an external charging unit, thus allowing operation of the apparatus 10 over a longer period of time. However replaceable disposable batteries would also be conceivable as energy storage 32.

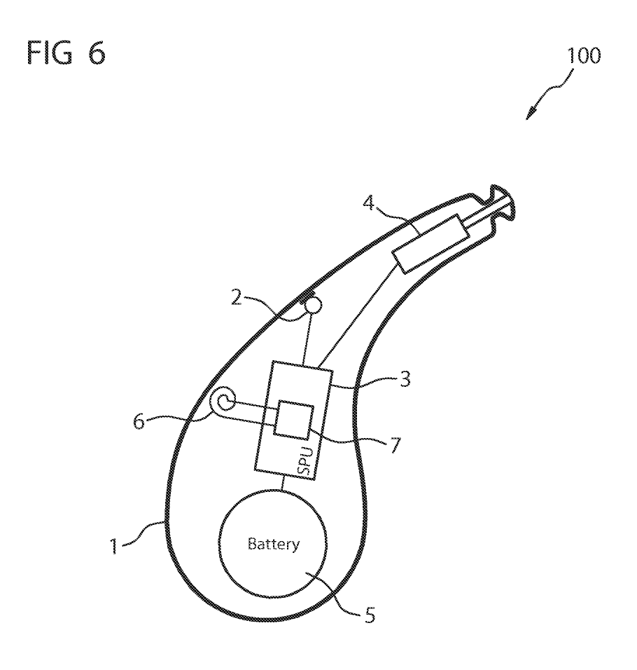

FIG. 6 shows the basic configuration of a hearing aid 100 for use with the inventive apparatus 10 for sending. A microphone 2 for recording sound or acoustic signals from the environment and converting these into an electrical signal is built into a hearing aid housing 1 to be worn behind the ear. A signal processing unit 3, which is also integrated in the hearing aid housing 1, processes the first audio signals. The output signal of the signal processing unit 3 is transferred to a loudspeaker or earpiece 4, which outputs an acoustic signal. The sound is optionally transferred by way of a sound tube, which is fixed with an otoplastic in the auditory canal, to the eardrum of the device wearer. However an alternative electromechanical converter is also conceivable, for example a bone conduction earpiece. Power is supplied to the hearing device and in particular to the signal processing unit 3 by a battery 5, which is also integrated in the hearing device housing 1 and is arranged in a rotatable battery compartment 20.

The hearing apparatus also has an induction coil 6 which is configured to receive an alternating electromagnetic field and to convert this into an electrical signal which is fed into the signal processing unit 3. The signal processing unit 3 has a communication unit 7 which demodulates and decodes the signal received from the induction coil 6 and provides this to the signal processing unit 3 for output via the earpiece. Methods which were developed for communication between two hearing aids 100 of a binaural hearing system are in particular used as the modulation method and for encoding the audio signals. On the one hand these are configured for low energy consumption and on the other hand in the case of such a hearing aid 100 it is no longer necessary to have separate elements to receive these types of alternating electromagnetic fields or to implement further algorithms for the apparatus 10, which would require additional storage space and processor resources.

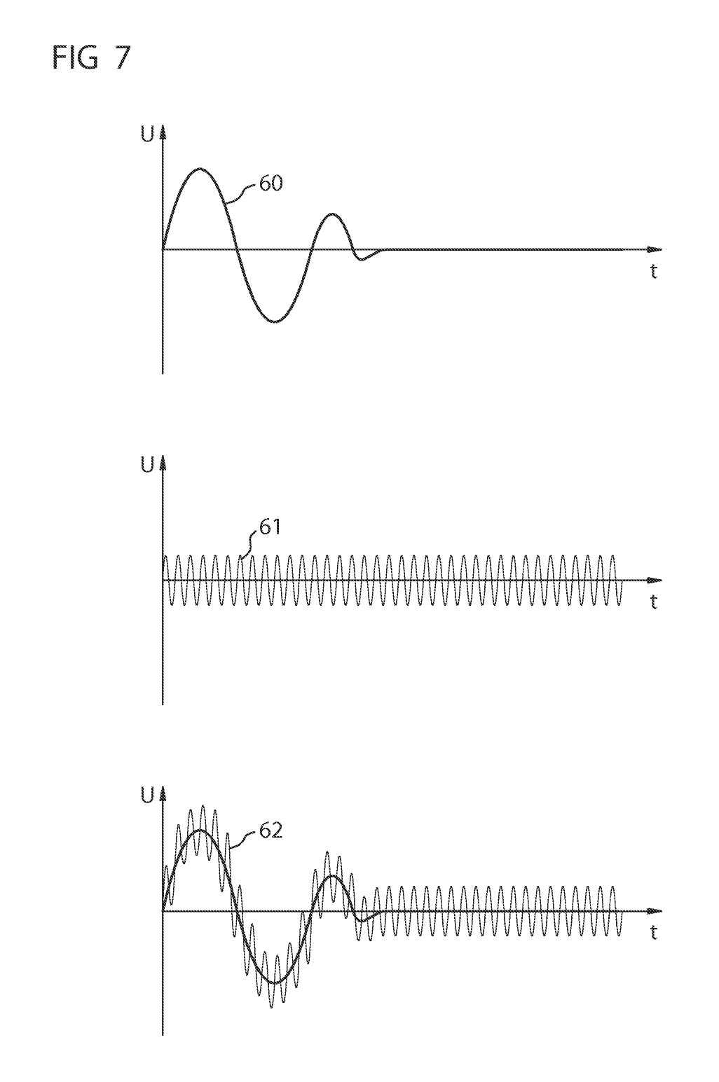

The top graph in FIG. 7 shows an audio signal 60 to be transferred. The audio signal 60 to be transferred subsides, so that no alternating current U is present for part of the time t. So as to ensure provision of power to the converter 40, it is envisaged in a conceivable embodiment of the inventive system 50 that an audio signal source 20 generates a third signal 61 in addition to the audio signal 60 to be transferred.

The third signal 61 in the embodiment shown is a high-frequency audio signal with constant amplitude. High-frequency audio signal is to be understood here to be audio signals with frequencies outside of the audible range of the person wearing the hearing aid. This is usually frequencies greater than 8 kHz, 10 kHz or 15 kHz which specifically still fall in a frequency range for which the audio signal source 20 is configured to generate and output said frequencies. Preferably the converter 40 is configured not to transfer these high-frequency audio signals by means of the induction loop 14 to a hearing aid 100. It can therefore for example be envisaged that upon entry into the converter 40 the first audio signal 62 is released from the high-frequency audio signal by a lowpass.

However it is also conceivable that the third signal is a DC signal. The audio signal source 20 must then be configured to output such a DC signal.

The third signal can also be used in an embodiment to transfer control signals to the hearing aid or hearing aids 100.

For example the third signal 61 shown in FIG. 7 can be amplitude-modulated or frequency-modulated with a code so as to transfer control instructions. In this case the controller 40 must be configured to demodulate this code and output it with suitable encoding, preferably digital, as part of the second signal via the induction loop 14. Accordingly the hearing aid 100 must be configured to recognize and execute the control instructions.

It is for example conceivable that a remote-control application on a smart phone generates these control instructions as an audio source 20 and encodes these in the third signal.

If the audio source 20 is a digital audio source it is also conceivable to incorporate the control instructions in a bit stream of the audio source and for example to differentiate this from the audio data by specific data packet identifiers.

Likewise a DC signal can be encoded as a third signal by switching on or off, whereby corresponding filters are required so as to avoid an audible crackle in the hearing aid.

Although the invention has been illustrated and described in greater detail on the basis of the preferred exemplary embodiment, the invention is not limited by the disclosed examples and other variations can be derived herefrom by the person skilled in the art without departing from the scope of protection of the invention.

1. An apparatus for sending a second digital audio signal to a hearing aid, the apparatus comprising:
a power supply;
an induction loop for sending an alternating magnetic field;
a controller being galvanically, capacitively or inductively connected to said induction loop, said controller configured to convert an incoming first audio signal into the second digital audio signal and configured to use the second digital audio signal to generate a further signal to send the second digital audio signal by means of said induction loop; and
said power supply configured to draw power needed to generate the further signal from the first audio signal.

2. The apparatus according to claim 1, wherein said controller has a monitoring device configured to monitor a level of the first audio signal in a predefined frequency range and to suppress a creation of the further signal if a predetermined threshold value of the level is not reached.

3. The apparatus according to claim 1, further comprising means configured so as to decode encoded control instructions in the first audio signal.

4. A system for sending a second digital audio signal to a hearing aid, the system comprising:
an apparatus, containing:
a power supply;
an induction loop for sending an alternating magnetic field;
a controller being galvanically, capacitively or inductively connected to said induction loop, said controller configured to convert an incoming first audio signal into the second digital audio signal and configured to use the second digital audio signal to generate a further signal to send the second digital audio signal by means of said induction loop;
said power supply configured to draw power needed to generate the further signal from the first audio signal; and
an audio signal source generating the first audio signal from an audio signal to be transferred and from a third signal, the third signal being suitable for ensuring said apparatus has sufficient power for sending by means of said power supply and wherein the third signal does not result in any audible noise for a person wearing the hearing aid.

5. The system according to claim 4, wherein the third signal is an electrical DC signal.

6. The system according to claim 4, wherein the third signal is an audio signal in a frequency range that is imperceptible to a person wearing the hearing aid.

7. The system according to claim 4, wherein said audio signal source configured to encode in the third signal control commands for said apparatus for sending.
